(19) United States
(12) Patent Application Publication
(10) Pub. No.: US 2026/0225587 A1
(43) Pub. Date: Aug. 6, 2026

(54) SYSTEM AND METHOD FOR PROVIDING DRIVE OUT GUIDANCE FOR VEHICLE

(71) Applicant: Torc Robotics, Inc., Blacksburg, VA (US)

(72) Inventors: Simon Schaefer, Stuttgart (DE); Carlo Elwinger, Maulbronn (DE); Janine Guenther, Leinfelden (DE)

(21) Appl. No.: 19/046,196

(22) Filed: Feb. 5, 2025

(51) Int. Cl. B60W 30/09; B60Q 1/50; B60W 30/095; B60W 50/14; B60W 60/00

(52) U.S. Cl. CPC B60W 30/09; B60Q 1/507; B60Q 1/543; B60W 30/0953; B60W 30/0956; B60W 50/14; B60W 60/0015; B60W 2050/146; B60W 2554/4029; B60W 2554/4042; B60W 2554/4044

(57) ABSTRACT

A system for providing drive out guidance for a vehicle is provided. The system includes sensors disposed around a drive out location of an environment. The drive out location includes an obstructed view area of the environment for the vehicle at a distance offset from the drive out location. The obstructed view area of the environment is within a field-of-view of the one or more sensors. A processing device is configured to acquire sensor data from the sensors representative of the obstructed view area of the environment, determine from the sensor data if the environment in the obstructed view area is clear from one or more objects, and transmit to at least one of the vehicle or an output source a signal indicative of if the environment in the obstructed view area is clear from the one or more objects.

### TECHNICAL FIELD

The field of the disclosure relates to drive out guidance and, in particular, to a system for providing drive out guidance for a vehicle in instances where an obstructed view of an area of a road exists.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

As vehicles—autonomous, semi-autonomous, and non-autonomous—travel between different locations, exiting of these locations may not always be safe due to restricted visibility. For example, if the vehicle is a truck with a trailer traveling from hub to hub, the exit from such hubs may not be optimally situated for visibility of the roadway near the hub. In particular, the geographic location of the hub may be selected based on economic efficiency, and the drive-out area may have limited visibility for the driver of the vehicle and/or the field-of-view of sensors associated with an autonomous vehicle. The restricted visibility impedes the ability to safely navigate the vehicle, increasing the risk of accidents and delays when exiting these locations or hubs.

Accordingly, there exists a need for a system and a method for providing drive out guidance for a vehicle to improve the visibility and ensure safe exit from a location when an obstructed view exists. These and other needs are met by the exemplary system for providing drive out guidance discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for providing drive out guidance for a vehicle is provided. The system includes one or more sensors disposed around a drive out location of an environment (as a non-limiting example, at or near a road). The drive out location includes an obstructed view area of the environment for the vehicle at a distance offset from the drive out location. The obstructed view area of the environment is within a field-of-view of the one or more sensors. The system includes a processing device in communication with the one or more sensors. The processing device is configured to execute instructions stored in a memory to perform operations including acquiring sensor data from the one or more sensors representative of the obstructed view area of the environment. The operations include determining from the sensor data if the environment in the obstructed view area is clear from one or more objects. The operations include transmitting to at least one of the vehicle or an output source a signal indicative of if the environment in the obstructed view area is clear from the one or more objects.

The vehicle can be, e.g., an autonomous vehicle, a semi-autonomous vehicle, a non-autonomous vehicle, or the like. The one or more sensors can include, e.g., a camera, radar, LiDAR, combinations thereof, or the like. The one or more sensors can be stationary mounted sensors, i.e., sensors disposed on static structures, such as buildings or poles. The vehicle includes one or more vehicle sensors with a vehicle field-of-view including the obstructed view area. The sensor data supplements data from the one or more vehicle sensors to provide coverage of the obstructed view area. The one or more objects can include, e.g., other vehicles, pedestrians, combinations thereof, or the like.

In some embodiments, the obstructed view area includes a road. In such embodiments, determining if the environment in the obstructed view area is clear from the one or more objects can include determining a speed and direction of travel of the one or more objects along the road. The operations can include determining if the vehicle is capable of exiting the drive out location onto the road without interfering with the one or more objects based on the speed and the direction of the one or more objects. In some embodiments, the obstructed view area is determined to be clear from the one or more objects if the sensor data indicates that no objects exist at the obstructed view area. In some embodiments, the obstructed view area is determined to be clear from the one or more objects if the sensor data indicates that the vehicle will not interfere with the one or more objects in the drive out location of the environment based on a detected speed and direction of travel of the one or more objects. In some embodiments, the obstructed view area is determined to not be clear from the one or more objects if the sensor data indicates that the vehicle will interfere with the one or more objects in the drive out location of the environment based on a detected speed and direction of travel of the one or more objects.

Transmitting to the vehicle can include transmitting to a graphical user interface of the vehicle if the environment in the obstructed view is clear from the one or more objects. In some embodiments, the output source can include a traffic signal. If the environment in the obstructed view area is clear from the one or more objects, the operations can include illuminating a green light on the traffic signal to indicate safe passage for the vehicle. If the environment in the obstructed view area is determined to not be clear from the one or more objects, the operations can include illuminating a red light on the traffic signal to indicate unsafe passage for the vehicle. The operations can include transmitting to at least one of the vehicle or the output source the signal indicative of if the environment in the obstructed view is not clear from the one or more objects.

In another aspect, an exemplary computer-implemented method for providing drive out guidance of a vehicle is provided. The method includes acquiring sensor data from one or more sensors disposed around a drive out location of an environment. The drive out location includes an obstructed view area of the environment for the vehicle at a distance offset from the drive out location. The obstructed view area of the environment is within a field-of-view of the one or more sensors. The sensor data is representative of the obstructed view area of the environment. The method includes executing instructions stored in a memory with a processing device in communication with the one or more sensors to perform operations including determining from the sensor data if the environment in the obstructed view area is clear from one or more objects. The operations include transmitting to at least one of the vehicle or an output source a signal indicative of if the environment in the obstructed view area is clear from the one or more objects.

In some embodiments, the obstructed view area can include a road and determining if the environment in the obstructed view area is clear from the one or more objects can include determining a speed and direction of travel of the one or more objects along the road.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for providing drive out guidance.

FIG. 7 is a flowchart of a method for driver guidance.

FIG. 8 is a schematic view of an environment in which a field-of-view of a vehicle sensor is obstructed.

FIG. 9 is a schematic view of an environment including an exemplary system for providing drive out guidance to determine if an obstructed view area of a vehicle sensor is clear.

FIG. 10 is a block diagram of an exemplary system for providing drive out guidance including an output source configured to visually indicate if a road in an obstructed view area is clear.

FIG. 11 is a block diagram of an exemplary system for providing drive out guidance including communication between and fusion of data from environment sensors and vehicle sensors to determine if a road in an obstructed view area is clear.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for providing drive out guidance includes sensors disposed around a drive out location (or any location) of an environment to assist with visibility of the vehicle exiting the environment. In some embodiments, the sensors of the environment can be used to determine if a roadway is clear for the vehicle to exit, and can output a signal to an output source (e.g., a traffic light) indicating whether the roadway is clear or not. In some embodiments, the sensors of the environment can be used to supplement the vehicle sensor data, and fusion of the sensor data can be performed to ensure full visibility of the roadway. The fused data can be transmitted to the vehicle such that the vehicle can exit the environment upon a determination that the roadway is clear. The system therefore provides for safe passage of the vehicle out of an environment in which an obstructed view area may exist.

In particular, the exemplary system addresses visibility challenges in drive-out areas of environments, such as transportation hubs, thereby enhancing the safety and efficiency of vehicle operations. Although discussed herein as being used at drive-out locations of the environment, it should be understood that the exemplary system can be similarly used in other scenarios, e.g., obstructed views around corners of buildings, obstructed views around street signs, obstructed views of objects and/or people behind trailer when vehicle is maneuvering backwards (due to occlusion by the trailer), or the like. Thus, the system assists with detection of approaching objects, such as other vehicles and/or pedestrians, located in an obstructed area of the field-of-view of the vehicle sensor(s), and alerts the vehicle regarding whether it is clear to proceed through an intersection. The environment sensors remain fixed to structures in the environment, such as building corners or walls, and are therefore described herein as stationary or static perception sensors.

In some embodiments, the system can rely on the output source, e.g., traffic light, to provide an indication to the vehicle regarding the clear or not clear status of the roadway. In such embodiments, the environment sensor data can be processed at a central processing device associated with the environment, and the output source can be activated accordingly. In some embodiments, a control or processing unit of the environment can transmit the environment sensor data to the vehicle, and a processing device of the vehicle can process the data to determine whether it is safe to drive through an intersection. Increased safety and confidence to exit an environment based on an increase in the field-of-view using stationary perception sensors is therefore achieved.

Several advantages are provided by the exemplary system. The local increase of operational design domain (ODD) is possible, e.g., unprotected left turns would be possible, or the like. Reduced sensor sets for the vehicle is possible. Detection of an area for vehicle sensors can be limited by physics and can be increased by environment sensors disposed outside of the vehicle. Safety can be increased by an increased field-of-view and more reliable detection, as well as efficiency in operation through increased field-of-view. In some embodiments, independency from authorities for placement of official signs/signals can be allowed. By using stationary sensors, the coordination of incoming and outgoing vehicles from an environment can be improved overall.

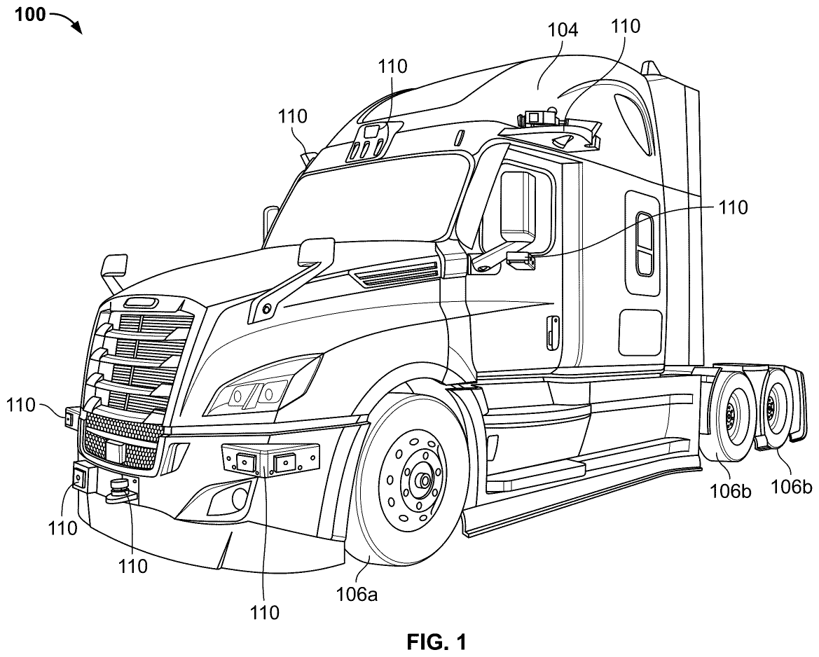

Various embodiments in the present disclosure are described with reference to FIGS. 1-11 below.

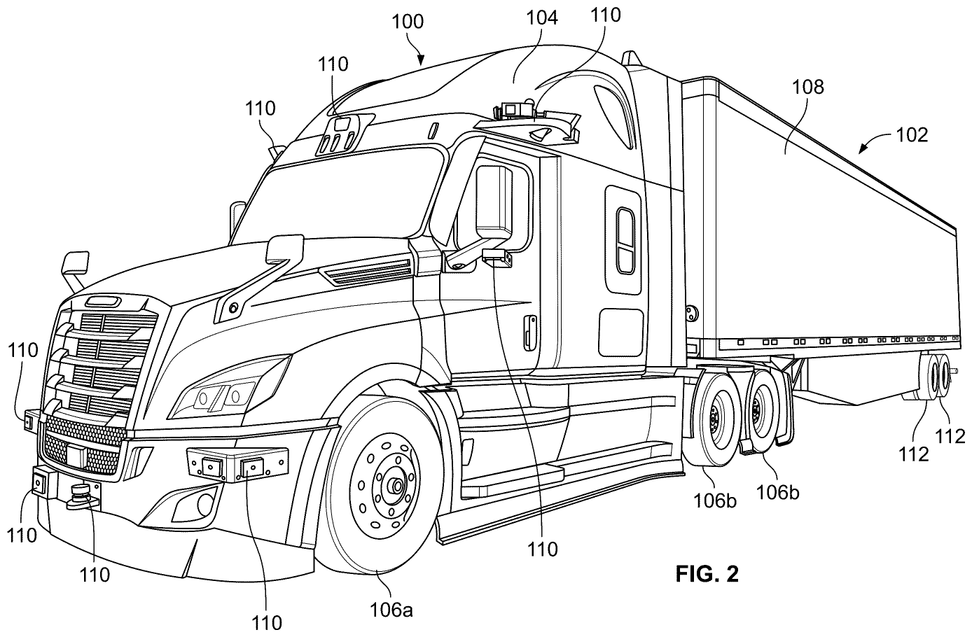

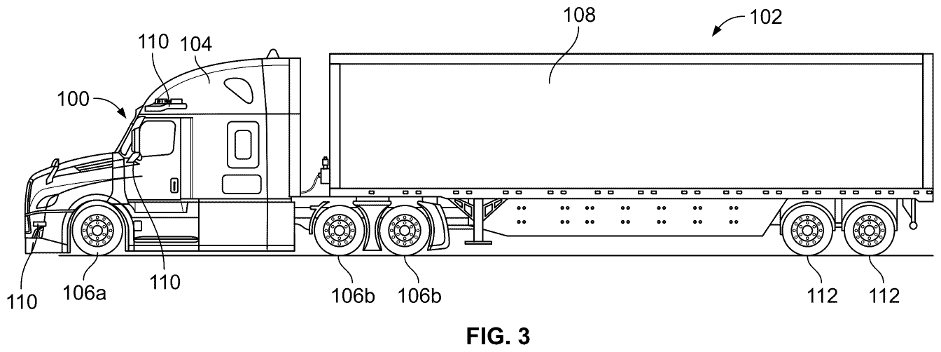

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

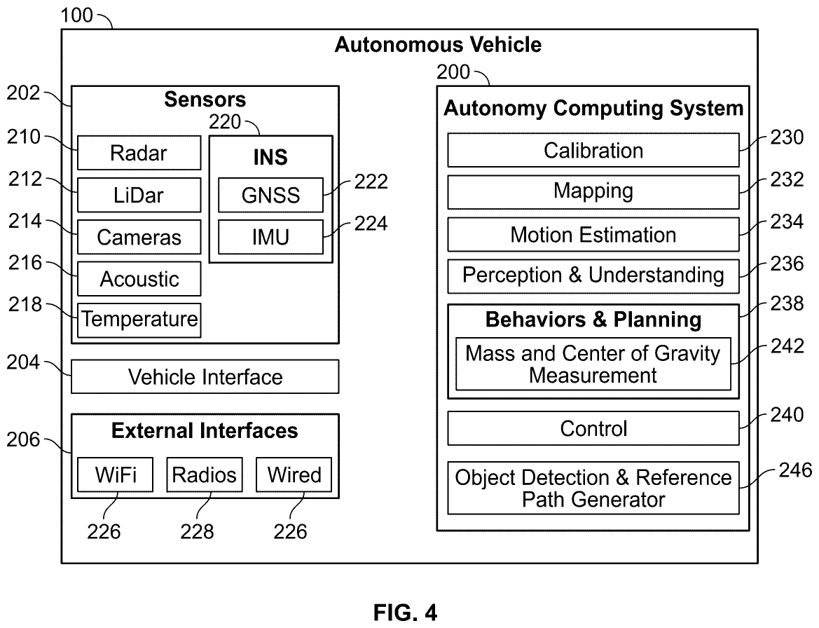

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

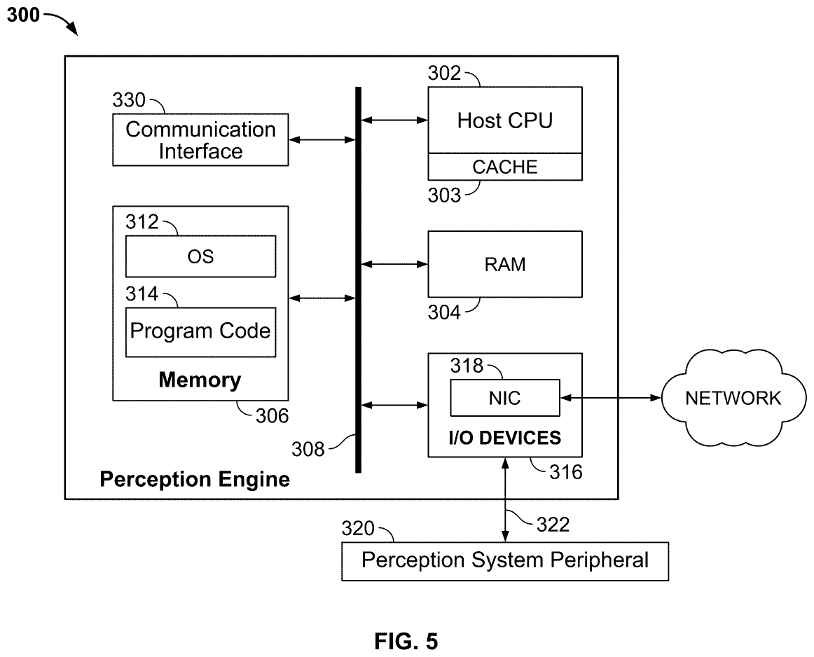

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

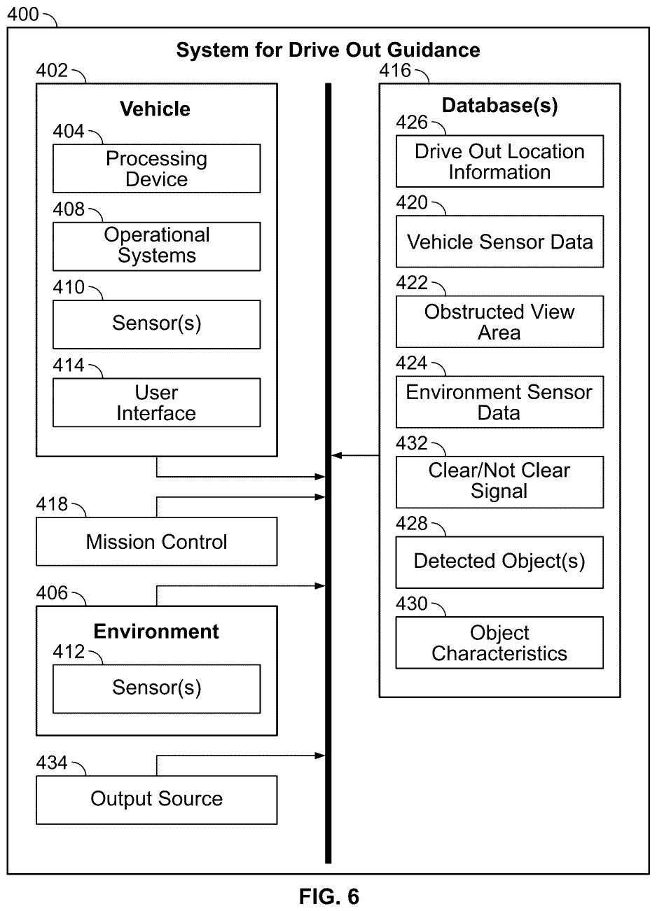

FIG. 6 is a block diagram of an exemplary system 400 for providing drive out guidance for a vehicle. The system 400 generally includes one or more vehicles 402 (e.g., autonomous vehicle 100, semi-autonomous vehicle, and/or non-autonomous vehicle). The vehicle 402 can include a processing device 404 (e.g., computing system 200, computing system 300, or the like) configured to receive and process data for moving through an environment 406. The vehicle 402 can include one or more operational systems 408 (e.g., mapping 232, motion estimation 234, perception and understanding 236, behaviors and planning 242, control 240, object detection and reference path generator 246, combinations thereof, or the like) for operating the vehicle 402 within the environment 406 using data from vehicle sensors 410.

In particular, the vehicle 402 can include one or more sensors 410 (e.g., sensors 202) for detecting the environment 406 and objects within the environment 406 around the vehicle 402. For example, the sensors 410 can assist the vehicle 402 in detecting and avoiding other vehicles traveling in the environment 406. The sensors 410 can include a field-of-view in which the sensors 410 can gather data. If all, or a portion of the field-of-view of one or more of the sensors 410 is obstructed, sensors 412 of the environment 406 can be used to supplement the vehicle sensor 410 data.

In some embodiments, the sensors 410, 412 can be, e.g., cameras, radar, LiDAR, combination thereof, or the like. In some embodiments, the sensors 410 can be, e.g., motion sensors, such as passive infrared (IR) sensors which detect movement of warm objects (e.g., humans, animals, or the like). In some embodiments, the sensors 410 can be, e.g., acoustic sensors, such as microphones to detect specific sounds. In some embodiments, the sensors 410 can be, e.g., pressure sensors, such as ground sensors which detect change in pressure (e.g., when someone walks over or moves into a relevant area). In some embodiments, the sensors 410 can be, e.g., temperature sensors, humidity sensors, rain sensors, brightness sensors, or the like, to understand lighting and road conditions. In some embodiments, the sensors 410 can be, e.g., inductive-loop traffic detectors, or the like.

The vehicle 402 can include a user interface 414 (e.g., vehicle interface 204) configured to receive/transmit and display data for operation of the system 400, as well as the vehicle 402 itself. The vehicle 402 can include one or more databases 416 (e.g., memory 306) configured to receive and electronically store data. In some embodiments, the database 416 can be stored externally from the vehicle 402 and the vehicle 402 can be in communication with the external database 416 for receiving and/or transmitting data associated with the system 400. In some embodiments, the database 416 can be stored at mission control 418 external to the vehicle 402 and in communication with the vehicle 402. In some embodiments, the database 416 can be located on the vehicle 402 itself. In some embodiments, one or more portions of the database 416 can be distributed across components of the system 400. The database 416 can store information relating to guiding the vehicle 402 through and out of the environment 406.

As the vehicle 402 travels within the environment 406, the vehicle sensors 410 are used to at least determine perception and localization data to assist movement of the vehicle 402 in the environment 406. The data is collected as vehicle sensor data 420 and is dependent on the field-of-view of the sensors 410. If the field-of-view of the sensors 410 is obstructed, an obstructed view area 422 exists in which data from the sensors 410 cannot be collected. The vehicle 402 (and/or the sensors 410) can transmit the obstructed view area 422 information to the database 416 to identify that assistance is needed for proper visibility and action to be taken by the vehicle 402. The environment sensors 412 each include a field-of-view that provides greater visibility of the environment 406, thereby supplementing any missing data from the vehicle sensors 410. The environment sensor 412 data can be stored as environment sensor data 424.

Such obstructed view area 422 can occur at various areas of the environment 406, including (but not limited to) the drive-out or exit location. The system 400 can store information 426 relating to the drive-out location in the environment 406, such as the location, dimensions, known obstructions, combinations thereof, or the like. In some embodiments, the information 426 can include, e.g., weather conditions, surface conditions, (temporary) traffic signs or construction, or the like. In some embodiments, the information 426 an include, e.g., details of traffic lights (such as minimum and maximum phase lengths of traffic light states), whether the switch is based on detected traffic, or the like. The drive-out or exit location may be in the form of a road in the environment 406 leading to an intersection with the primary road outside of the environment 406. The environment 406 can be a hub with a surrounding wall or fence, resulting in potential obstructions of the field-of-view of the vehicle sensors 410. Similarly, street signs, trees, or other objects, can create at least partial obstructions of the field-of-view of the vehicle sensors 410. Such obstructions, even if partial, create unsafe conditions for exiting the environment 406 and driving into the intersection.

In some embodiments, if obstructions are detected, the vehicle 402 can transmit an alert or request for assistance to mission control 418 (which can act as a central control or processing unit). In some embodiments, the system 400 can automatically function to transmit environment sensor 412 data to the vehicle 402 (and/or mission control 418) to ensure full visibility is provided during the entire operation of the vehicle 402 through and out of the environment 406.

If an obstructed view area 422 is detected in the vehicle sensor data 420 and assistance is required, the system 400 can rely on the environment sensor data 424 to supplement the vehicle sensor data 420 and acquire information regarding objects detected in the obstructed view area 422. In particular, the sensors 410 of the vehicle 402 are configured to detect and identify various objects in the environment 406 and outside of the environment 406. The sensors 412 of the environment 406 can similarly detect and identify various objects in the environment 406 and outside of the environment 406. The data acquired by the sensors 412 is therefore complementary to the data acquired by the sensors 410, and vice versa.

The sensors 412 are therefore used to detect objects 428 (if any) in the obstructed view area 422, and data associated with the detected objects 428 is transmitted to mission control 418 and/or the vehicle 402 for processing and fusion with the vehicle sensor data 420. The detected objects 428 can include, e.g., other vehicles, pedestrians, bicyclists, or the like. In particular, detection of the objects 428 is intended to identify whether any object is within the obstructed view area 422 and potentially traveling towards the intersection in which the vehicle 402 will be passing, thereby determining if it is safe for the vehicle 402 to travel through the intersection.

The sensors 412 can be used to determine various object characteristics 430 associated with the detected object(s) 428. The characteristics 430 can include, e.g., an object size, an object trajectory, an object speed, an object type, combinations thereof, or the like. The characteristics 430 can therefore be used to determine whether the detected object 428 is problematic and creates a safety risk (e.g., if the object 428 is another vehicle traveling in the direction of the intersection). For example, the characteristics 430 can affect whether the vehicle 402 will be able to turn into the intersection and accelerate sufficiently quickly to avoid interfering with travel of the detected object 428 (e.g., to avoid a collision with the object 428). In some embodiments, the environment sensor data 424 can be processed by an external processing device/unit, controller or mission control 418, by the processing device 404 of the vehicle 402, or both.

If, based on the environment sensor data 424, it is determined that detected object(s) 428 is problematic and creates a safety risk for passage through the intersection at the exit of the environment 406, the system 400 can generate a “not clear” signal 432, and instructing the vehicle 402 to wait until a “clear” signal 432 is generated instead. For example, if another vehicle is traveling through the obstructed view area 422 and is detected by the environment sensor 412, a signal 432 can be transmitted to the vehicle 402 to wait until the other vehicle has passed the intersection and it is safe to drive through the intersection. As another example, if no objects 428 are detected in the obstructed view area 422 (and the vehicle sensors 410 have not detected problematic objects), a “clear” signal can be transmitted to the vehicle 402 to indicate that passage through the intersection is safe.

In some embodiments, rather than transmitting the signal to the vehicle 402 (or the processing device 404 of the vehicle 402 determining if it is safe to pass through the intersection and exit the environment 406), the system 400 can include an external output source 434 through which the clear or not clear signal 432 can be output. In some embodiments, the output source 434 can be in the form of a traffic light, for example, with green, yellow and red lights, with yellow indicating that caution should be taken when entering the intersection. In some embodiments, the traffic light can include only a green and red light to indicate clear or not clear.

The output source 434 can be in communication with mission control 418, which determines based on the data 420, 424 if a clear or not clear signal should be generated by the output source 434. The sensors 410 of the vehicle 402 (or the driver of the vehicle 402) can visualize or detect the signal provided by the output source 434, and use the signal to wait or proceed into the intersection to exit the environment 406. Thus, the system 400 ensures that full visibility of any obstructed areas of the road are provided to make a fully informed decision regarding passage of the vehicle 402 out of the environment 406.

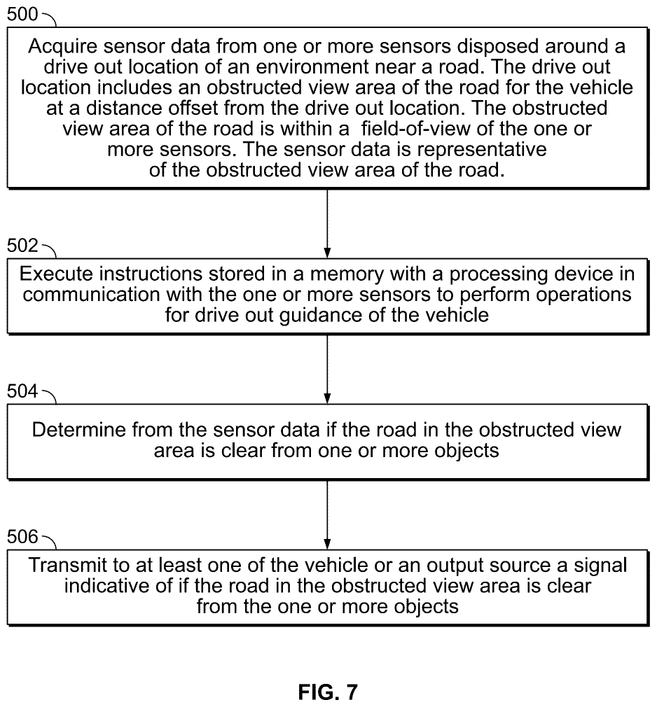

FIG. 7 is a flowchart of a method for providing drive out guidance for a vehicle by the exemplary system 400 discussed herein. At 500, sensor data is acquired from one or more sensors disposed around a drive out location of an environment near a road. The drive out location includes an obstructed view area of the road for the vehicle at a distance offset from the drive out location. The obstructed view area of the road is within a field-of-view of the one or more sensors, and the sensor data is representative of the obstructed view area of the road.

At 502, instructions stored in a memory are executed with a processing device in communication with the one or more sensors to perform operations for providing drive out guidance of the vehicle. At 504, a determination is made from the sensor data if the road in the obstructed view area is clear from one or more objects. At 506, a signal indicative of if the road in the obstructed view area is clear from the one or more objects is transmitted to the vehicle and/or an output source.

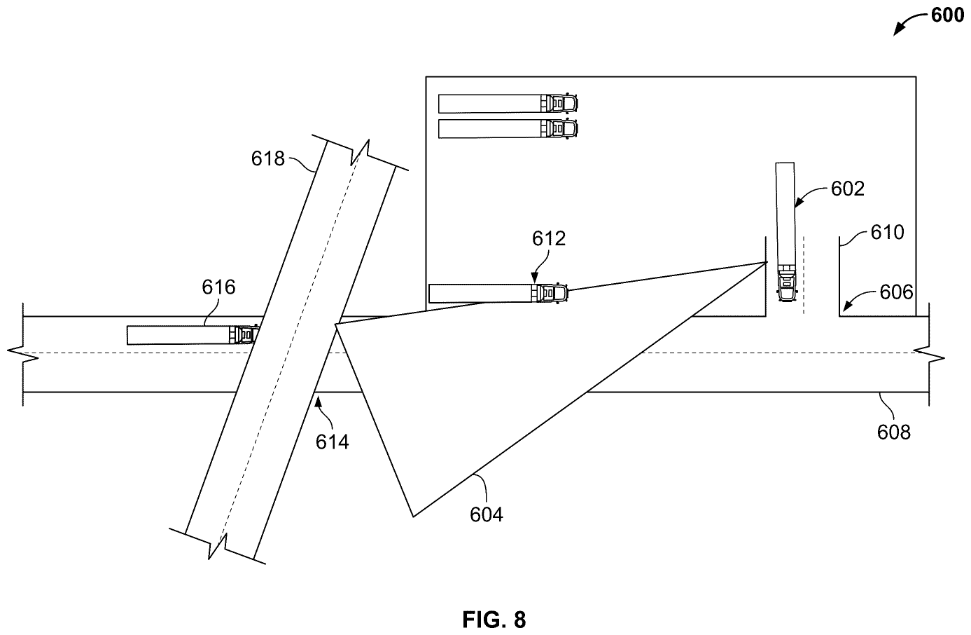

FIG. 8 is a schematic view of an environment 600 in which a vehicle 602 is traveling. The vehicle 602 includes one or more sensors, each including a field-of-view 604. Only one field-of-view 604 is illustrated in FIG. 8 for clarity. As the vehicle 602 approaches an intersection 606 between a secondary road 610 and a primary road 608 at the exit of the environment 600, the sensors of the vehicle 602 gather data regarding detection of objects along the road 608 to determine if it is safe for the vehicle 602 to enter and pass through the intersection 606.

In the example of FIG. 8, another vehicle 612 partially blocks the field-of-view 604 of the sensor on the vehicle 602, resulting in a partially obstructed area view 614 of the vehicle 602 sensor data. A bridge 618 may similarly partially obstruct the field-of-view 604 of the sensor on the vehicle 602. In some instances, the sensor of the vehicle 602 may have a limited distance for the field-of-view 604, and this can create the obstructed area view 614, i.e., an area which the vehicle 602 sensors are unable to gather data on for detection of other objects. In this example, the vehicle 602 sensors are unable to detect the vehicle 616 traveling along the road 608 towards the intersection 606, thereby creating an unsafe condition for the vehicle 602 when determining if the vehicle 602 can pass into and through the intersection 606.

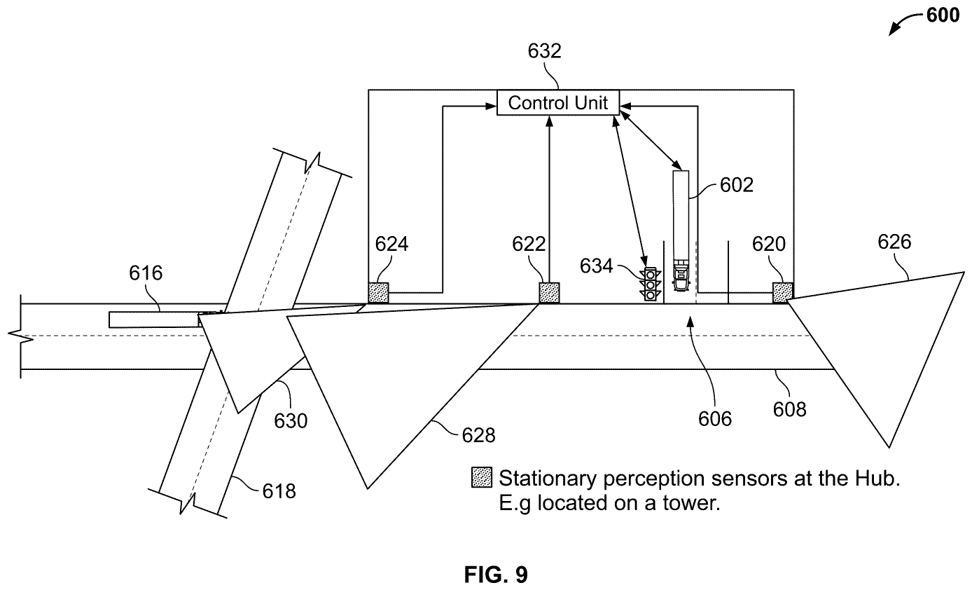

The exemplary system 400 for providing drive out guidance assists with minimizing or preventing such unsafe conditions, as illustrated in FIG. 9. The same reference numbers are used as FIG. 8 for the same structures. Rather than relying solely on the sensors of the vehicle 602, the system 400 includes one or more sensors 620, 622, 624 mounted within the environment 600. For example, the sensor 620 can include a field-of-view 626 mounted at a corner of the environment 600 near the road 608 to provide visibility to the left of the intersection 606. As a further example, the sensor 622 can include a field-of-view 628 mounted at a central area of the environment 600 near the road 608 to provide visibility to the right of the intersection 606. As a further example, the sensor 624 can include a field-of-view 630 mounted at an opposing corner of the environment 600 near the road 608 to provide visibility under, over and/or around the bridge 618. The sensors 620, 622, 624 provide supplemental data to the data from the vehicle 602 sensor (expanding the field-of-view of the vehicle 602 sensor) to ensure that fusion of the data can be used to visualize any areas obstructed for the sensor of the vehicle 602.

In some embodiments the system 400 can include a control unit 632, e.g., a central processing device, mission control, or the like, configured to receive data from the sensors 620, 622, 624 and transmit the data to the vehicle 602 for further processing. In some embodiments, the control unit 632 can receive data from the sensors of the vehicle 602 and fuses the data with data from the sensors 620, 622, 624 to ensure full visibility for the vehicle 602 at the intersection 606. Based on the data, the vehicle 602 can determine (or is instructed by the control unit 632) that the intersection 606 is clear and safe to travel through. In some embodiments, the system 400 can include an external output source 634, e.g., a traffic light, at the intersection 606. In such embodiments, the output source 634 can indicate visually by using a green, yellow or red light whether the intersection 606 is clear to pass through. In some embodiments, the output source 634 can be a traffic light for the intersection 606, and the system 400 can regulate operation of the traffic light for the intersection based on vehicles on the secondary or primary road and based on the sensor 620, 622, 624 data. Obstructed view areas for the vehicle 602 sensor are therefore supplemented by the sensors 620, 622, 624 for safe travel of the vehicle 602 through the intersection 606.

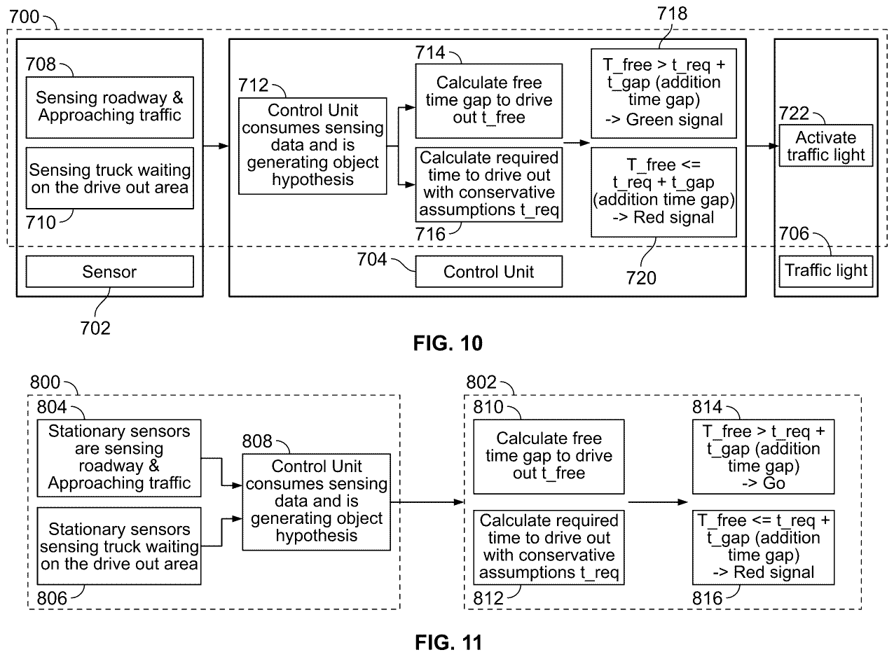

FIG. 10 is a block diagram of the exemplary system for providing drive out guidance including an output source configured to visually indicate if a road is an obstructed view area is clear or not. The environment 700 can include one or more sensors 702, a control unit 704 (e.g., a processing device), and a traffic light 706 (e.g., an output source). At 708, the sensor 702 detects the roadway at the exit intersection of the environment 700 and any approaching traffic (e.g., objects. At 710, the sensor 702 also detects the truck or vehicle waiting at the drive-out area or exit of the environment 700. The data from the sensor 702 is transmitted to the control unit 704.

At 712, the control unit 704 processes the data from the sensor 702 and generates an object hypothesis, i.e., the expected trajectory of any detected objects relative to the intersection at the drive-out area. In particular, at 714, the control unit 704 calculates the free time gap for the vehicle to drive out through the intersection (t_free). At 716, the control unit 704 calculates the required time to drive out with conservative assumptions (t_req). In some embodiments, the conservative assumptions can be based on parameters, such as, e.g., reaction times, acceleration times, combinations thereof, or the like. For example, the parameters can consider the worst-case acceleration rates for the vehicle (e.g., a heavily loaded vehicle). As a further example, the parameters can consider the worst-case road conditions, e.g., limiting the assumed possible acceleration of the vehicle due to the possibility of wheel sleep on wet, snowy, or sand covered surfaces. At 718, if t-free is greater than t_req plus an additional time gap (t_gap), a green signal (i.e., clear path) is determined. In some embodiments, the time gap can be added as a safety margin, adding extra buffer time to account for uncertainties and/or to ensure other vehicles are comfortable with the minimum required time gap. At 720, if t_free is less than or equal to t_req plus t_gap, a red signal (i.e., non-clear path) is determined. The green or red signal directive is transmitted to the traffic light 706, with the corresponding activation of the traffic light 706 at 722.

FIG. 11 is a block diagram of the exemplary system for providing drive out guidance including communication between and fusion of data from environment sensors and vehicle sensors to determine if a road in an obstructed view area is clear or not. The environment 800 of FIG. 11 is in communication with a vehicle 802. At 804, sensors of the environment 800 detect the roadway and any approaching traffic at an intersection of an exit of the environment 800. At 806, the sensors of the environment 800 further detect the vehicle waiting at the exit or drive-out area of the environment 800. At 808, the data from the sensors is transmitted to a control unit of the environment 800, which processes the data and generates an object hypothesis, i.e., the expected trajectory of any detected objects relative to the intersection at the drive-out area. The object hypothesis is transmitted to the vehicle 802.

At 810, a processing device of the vehicle 802 calculates the free time gap to drive out through the intersection (t_free) and, at 812, the processing device of the vehicle 802 calculates the required time to drive out with conservative assumptions (t_req). At 814, if t_free is greater than t_req plus t_gap (an additional time gap), the processing device instructs the vehicle 802 to proceed through the intersection. At 816, if t_free is less than or equal to t_req plug t_gap, the processing device instructs the vehicle 802 to stop and wait until the detected objects have passed the intersection and sufficient time is determined for passage of the vehicle 802 through the intersection. The system can therefore be used with a central control unit of the environment, a processing device of the vehicle, or combinations therefore, to analyze and fuse data from the vehicle and the environment sensors in determining if it is safe for the vehicle to pass through the intersection.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for providing drive out guidance for a vehicle, the system comprising:
one or more sensors disposed around a drive out location of an environment, wherein the drive out location includes an obstructed view area of the environment for the vehicle at a distance offset from the drive out location, and wherein the obstructed view area of the environment is within a field-of-view of the one or more sensors; and
a processing device in communication with the one or more sensors, wherein the processing device is configured to execute instructions stored in a memory to perform operations comprising:
acquiring sensor data from the one or more sensors representative of the obstructed view area of the environment;
determining from the sensor data if the road in the obstructed view area is clear from one or more objects; and
transmitting to at least one of the vehicle or an output source a signal indicative of if the environment in the obstructed view area is clear from the one or more objects.

2. The system of claim 1, wherein the vehicle is an autonomous vehicle.

3. The system of claim 1, wherein the vehicle is a semi-autonomous vehicle or a non-autonomous vehicle.

4. The system of claim 1, wherein the one or more sensors include at least one of a camera, radar, or LiDAR.

5. The system of claim 1, wherein the one or more sensors are stationary mounted sensors.

6. The system of claim 1, wherein the vehicle includes one or more vehicle sensors with a vehicle field-of-view including the obstructed view area.

7. The system of claim 6, wherein the sensor data supplements data from the one or more vehicle sensors to provide coverage of the obstructed view area.

8. The system of claim 1, wherein the one or more objects include other vehicles.

9. The system of claim 1, wherein the one or more objects include pedestrians.

10. The system of claim 1, wherein the obstructed view area includes a road, and wherein determining if the environment in the obstructed view area is clear from the one or more objects comprises determining a speed and direction of travel of the one or more objects along the road.

11. The system of claim 10, wherein the operations comprise determining if the vehicle is capable of exiting the drive out location onto the road without interfering with the one or more objects based on the speed and the direction of the one or more objects.

12. The system of claim 1, wherein the obstructed view area is clear from the one or more objects if the sensor data indicates that no objects exist at the obstructed view area.

13. The system of claim 1, wherein the obstructed view area is clear from the one or more objects if the sensor data indicates that the vehicle will not interfere with the one or more objects in the drive out location of the environment based on a detected speed and direction of travel of the one or more objects.

14. The system of claim 1, wherein the obstructed view area is not clear from the one or more objects if the sensor data indicates that the vehicle will interfere with the one or more objects in the drive out location of the environment based on a detected speed and direction of travel of the one or more objects.

15. The system of claim 1, wherein transmitting to the vehicle includes transmitting to a graphical user interface of the vehicle if the environment in the obstructed view is clear from the one or more objects.

16. The system of claim 1, wherein the output source include a traffic signal.

17. The system of claim 16, wherein if the environment in the obstructed view area is clear from the one or more objects, the operations comprise illuminating a green light on the traffic signal to indicate safe passage for the vehicle, and wherein if the environment in the obstructed view area is not clear from the one or more objects, the operations comprise illuminating a red light on the traffic signal to indicate unsafe passage for the vehicle.

18. The system of claim 1, wherein the operations comprise transmitting to at least one of the vehicle or the output source the signal indicative of if the environment in the obstructed view is not clear from the one or more objects.

19. A computer-implemented method for providing drive out guidance of a vehicle, the computer-implemented method comprising:
acquiring sensor data from one or more sensors disposed around a drive out location of an environment, the drive out location includes an obstructed view area of the environment for the vehicle at a distance offset from the drive out location, and the obstructed view area of the environment is within a field-of-view of the one or more sensors, wherein the sensor data is representative of the obstructed view area of the environment; and
executing instructions stored in a memory with a processing device in communication with the one or more sensors to perform operations comprising:
determining from the sensor data if the environment in the obstructed view area is clear from one or more objects; and
transmitting to at least one of the vehicle or an output source a signal indicative of if the environment in the obstructed view area is clear from the one or more objects.

20. The method of claim 19, wherein the obstructed view area includes a road, and determining if the environment in the obstructed view area is clear from the one or more objects comprises determining a speed and direction of travel of the one or more objects along the road.
